(19) United States
(12) Patent Application Publication
(10) Pub. No.: US 2026/0110572 A1
(43) Pub. Date: Apr. 23, 2026

(54) DiffOptics: A conditional diffusion model for optics sensing data imputation

(71) Applicant: NEC Laboratories America, Inc., Princeton, NJ (US)

(72) Inventors: Zhuocheng Jiang, Plainsboro, NJ (US); Yue Tian, Princeton, NJ (US); Yangmin Ding, East Brunswick, NJ (US); Sarper Ozharar, Pennington, NJ (US); Ting Wang, West Windsor, NJ (US)

(73) Assignee: NEC Laboratories America, Inc., Princeton, NJ (US)

(21) Appl. No.: 19/360,976

(22) Filed: Oct. 16, 2025

Related U.S. Application Data
(60) Provisional application No. 63/708,311, filed on Oct. 17, 2024.

(51) Int. Cl. G01H 9/00; G10L 25/30

(52) U.S. Cl. CPC G01H 9/004; G10L 25/30

(57) ABSTRACT

A generative Artificial Intelligence (AI) framework is presented based on a conditional diffusion model for distributed acoustic sensing (DAS) data imputation. The proposed model, named “DiffOptics,” is capable of generating high-quality fiber sensing data by learning the distribution of existing acoustic sensing data and conditioning on an adjacent acoustic sensing signal. DiffOptics is designed to address two critical challenges in abnormal acoustic event detection: (1) DAS data imputation to enhance spatial resolution for more accurate event analysis and reduced data storage, and (2) the generation of synthetic DAS data to improve the performance of machine learning models for recognizing hazardous events. The model is evaluated in a real-scale testbed utilizing telecom fiber cables on utility poles to generate high-quality data of various acoustic events

### CROSS REFERENCE TO RELATED APPLICATIONS

This application claims the benefit of U.S. Provisional Patent Application Ser. No. 63/708,311 filed Oct. 17, 2024, the entire contents of which is incorporated by reference as if set forth at length herein.

### FIELD OF THE INVENTION

This application relates generally to distributed fiber optic sensing (DFOS) systems and methods. More particularly, it pertains to DFOS/Distributed Acoustic Sensing (DAS) conditional diffusion model for sensing data imputation.

### BACKGROUND OF THE INVENTION

Distributed Acoustic Sensing (DAS) is a DFOS technology that uses fiber optic cables to detect acoustic vibrations. Its unique ability to detect small vibrations over long distances in real-time makes it an invaluable tool for monitoring and protecting critical infrastructures such as railroads, telecommunications networks, bridges, roads and electrical power generation and distribution systems.

As those skilled in the art will understand and appreciate, since most collected DAS data are ambient (without significant acoustic events), a relatively large step size during data collection is generally utilized. Unfortunately, this approach risks missing critical data from important acoustic events, such as fuse explosions or transformer failures.

### SUMMARY OF THE INVENTION

The above problem is solved and an advance is made in the art according to aspects of the present disclosure directed to an innovative approach to DFOS/DAS namely, a diffusion Artificial Intelligence (AI) model we call “DiffOptics” that generates missing data and enhances detection of key acoustic events, thereby facilitating more comprehensive and accurate DFOS/DAS analyses.

As we shall show and describe, our inventive DiffOptics is a diffusion model that generates high quality acoustic data for optical sensing imputation—and in particular—DFOS/DAS. As we demonstrate, we employ an exciter to broadcast acoustic signal tracks on wooden utility poles within a real-scale testbed, simulating several acoustic events in an electrical power grid. A distributed acoustic sensing—DAS—system connected to the optical fiber cable collects 2D waterfall matrix from which a conditional diffusion model is developed to enrich important acoustic sensing events.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative testbed setup for experiments according to aspects of the present disclosure.

FIG. 3 is a schematic diagram showing illustrative field setup of data collection experiments, 2D waterfall plot and extracted 1D time series according to aspects of the present disclosure.

FIG. 4 is a pseudo-code listing of our Algorithm 1—Training, and Algorithm 2—Sampling according to aspects of the present invention.

FIG. 5 is a schematic diagram showing an illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

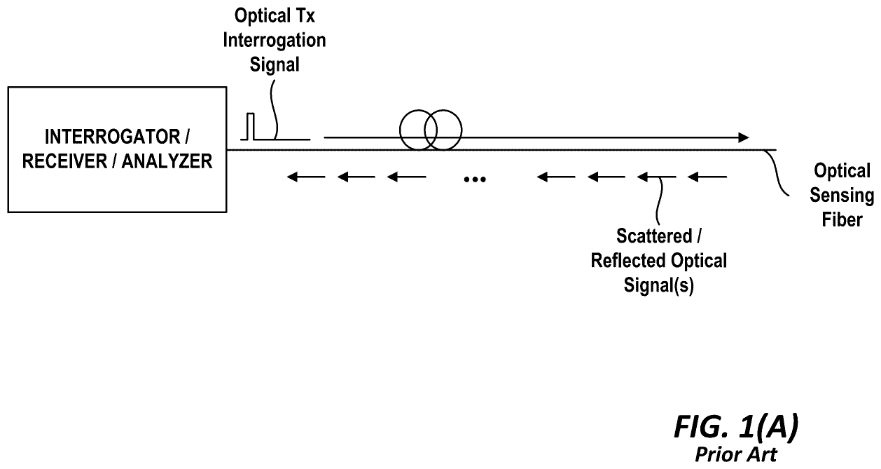

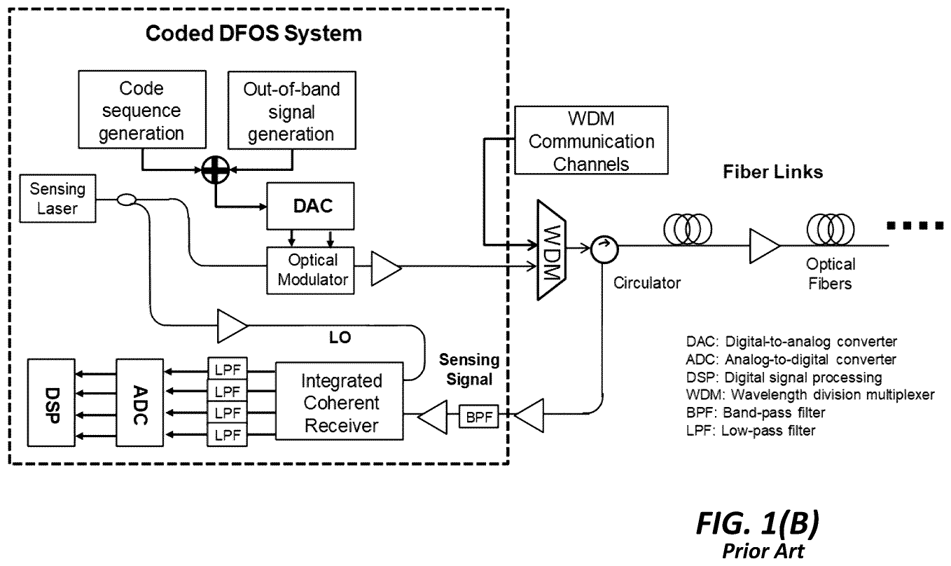

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

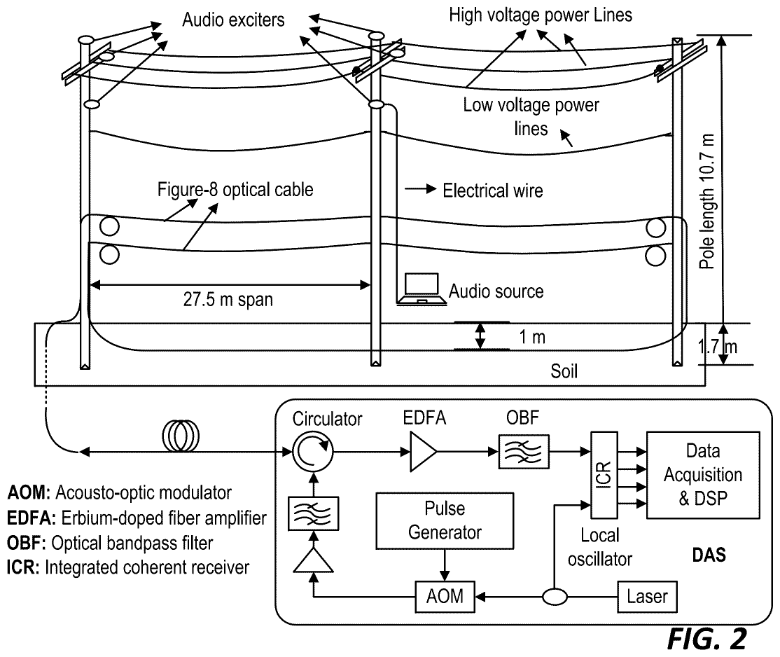

FIG. 2 is a schematic diagram showing illustrative testbed setup for experiments according to aspects of the present disclosure. We conducted our experiments for fuse explosion detection on a real-scale testbed, as shown in FIG. 2, comprising three type-II wooden utility poles, which are broadly used in distribution grids in the United States. A figure-8 self-supporting cable hosting 36 single mode fiber (G652D) cores in 6 loose tubes was deployed at the lower layer and went over the three poles for two rounds.

Dummy power lines were installed at the top and middle layers to demonstrate a typical power distribution setup. On each pole, three 25-Watt audio exciters nested in weather-proof housings were installed at the top (Exciter 1), at the crossarm (Exciter 2) and on the body around 1 m below the crossarm (Exciter 3) respectively. They were driven by an audio source to emulate various acoustic and vibration events at different locations on the poles.

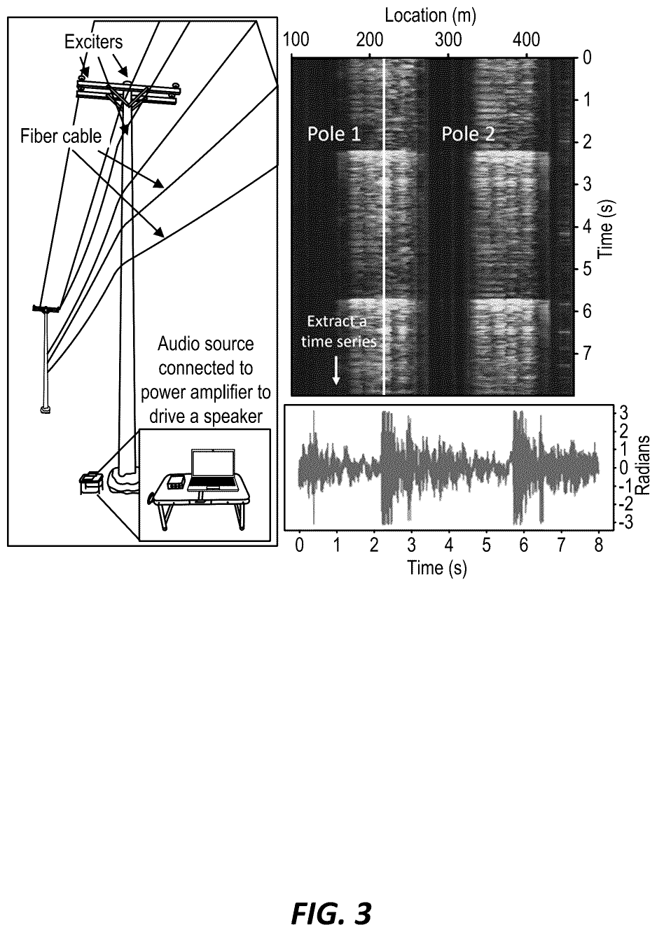

FIG. 3 is a schematic diagram showing illustrative field setup of data collection experiments, 2D waterfall plot and extracted 1D time series according to aspects of the present disclosure.

Data collection. We emulated four acoustic events that produce similar impulse vibration profiles and designed a diffusion model by learning the distribution of collected acoustic aim to imputate the acoustic sensing data. We utilized the pole-mounted exciters to play real-world recordings of fuse cutoff blowing, transformer explosion, gunshot and bird chirping. In addition, we also knocked the pole with a hammer to generate impulse vibrations directly.

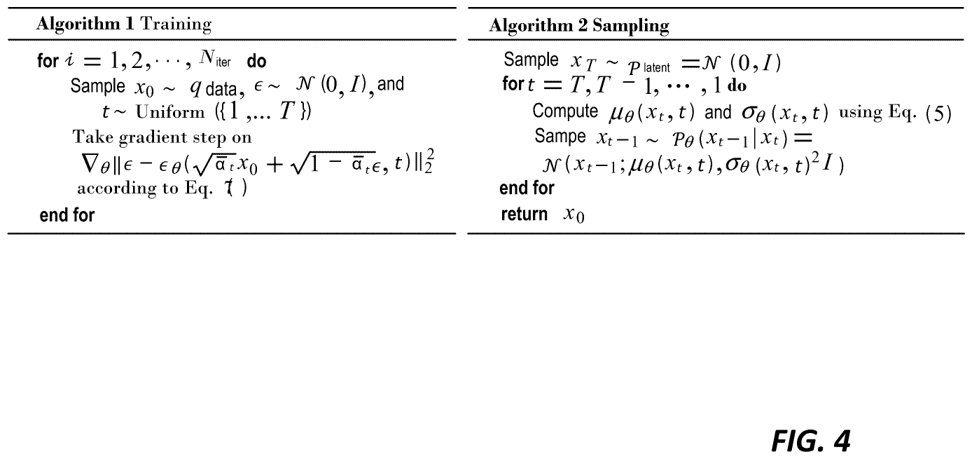

FIG. 4 is a pseudo-code listing of our Algorithm 1—Training, and Algorithm 2—Sampling according to aspects of the present invention.

We designed a diffusion probabilistic model for distributed acoustic sensing data that included two processes: the diffusion process, and the reverse process. The overall algorithm is shown in FIG. 4.

We define q_{data}(x₀) as the DAS data distribution, and the diffusion process is defined by a fixed Markov chain from data x₀ to the latent variable x_{T}:

$$q ( {x}_{1} , … , {x}_{T} \vert {x}_{0} ) = {\prod }_{t = 1}^{T} q ( {x}_{t} \vert {x}_{t - 1} ) ,$$

and the reverse process is defined by a Markov chain from x_{T} to x₀ parameterized by θ:

$${p}_{θ} ( {x}_{0} , … , {x}_{T - 1} \vert {x}_{T} ) = {\prod }_{t = 1}^{T} {p}_{θ} ( {x}_{t - 1} \vert {x}_{t} ) ,$$

The goal of reversed process is to eliminate the Gaussian noise added in the diffusion process.

Network structure is built based on a bidirectional dilated convolution architecture, it includes a stack of residual layers with multiple residual channels. We use a bidirectional dilated convolution with kernel size 3 in each layer. We then apply three fully connected (FC) layers on the encoding, where the first two FCs share parameters among all residual layers. The last residual-layer-specific FC maps the output of the second FC into a embedding vector. We next broadcast this embedding vector over length and add it to the input of every residual layer.

Conditional of the network. We evaluate the diffOptics as a neural conditioned on mel spectrograms. Initially, we up sample the mel spectrogram to match the waveform length using transposed 2D convolutions.

As those skilled in the art will understand, a mel spectrogram is a visual representation of an audio signal that shows how its frequency content changes over time, similar to a regular spectrogram, but with a key difference: the y-axis is a mel scale instead of a linear scale. This scale is designed to better reflect how humans perceive pitch, emphasizing lower frequencies and compressing higher frequencies. This makes it a useful tool in speech and audio processing for machine learning, as it provides a more perceptually relevant feature representation.

After applying a layer-specific Conv1×1 mapping to expand the mel bands into 2C channels, the conditioner is incorporated as a bias term in the dilated convolution of each residual layer.

### Experimental Setup and Data Collection

We conducted our experiments on a full-scale testbed, as illustrated in FIG. 2, which consists of three Type-II wooden utility poles, commonly used in distribution grids across the United States. A figure-8 self-supporting cable containing 36 single-mode fiber (G652D) cores housed in 6 loose tubes was deployed in the lower layer, looping over the three poles twice. To simulate a typical power distribution setup, dummy power lines were installed at the top and middle layers for mechanical demonstration.

On each pole, three 25-Watt audio exciters nested in weather-proof housings were installed at the top, at the crossarm and around 1 m below the crossarm, respectively. Driven by an audio source, they could emulate various acoustic events at different locations on the poles. As illustrated in the figures, a coherent-detection-based DAS system was connected to one core of this 1-km long fiber cable for data collection. In the DAS system, an acousto-optic modulator (AOM) is utilized to generate optical pulses with 40-ns width to interrogate the fiber strain changes. The full polarization and phase information recovered by coherent detection greatly reduces the chance of polarization fading. The DAS was configured with a pulse repetition rate of 20 kHz, and a gauge length of 4.08 meters, and had a noise floor of 27 Hz at 1 km away.

In our experimental study, we emulated fuse-cutout blowing event as well as three other comparable events that produce similar impulse vibration profiles and designed a machine learning model to distinguish fuse cutout blowing from other false events. We utilized the pole-mounted exciters to play real-world audio recordings of fuse cutoff blowing, transformer explosion and gunshot. In addition, we also knocked the pole with a hammer to generate impulse vibrations directly.

The field setup of our data collection experiments, showing the audio source connected to an exciter through an audio amplifier. The DAS system measures optical phase differences between adjacent locations separated by the gauge length along the fiber cable, forming a 2D spatio-temporal data matrix, or waterfall plot as shown in the figures. Each column in the waterfall plot represents the time series data at the corresponding location as plotted. Therefore, the rich information enables simultaneous monitoring of acoustic events at every location on the cable and consequently allowing for the detection and precise localization of acoustic anomalies across the entire fiber line. In this study, we refined the 2D waterfall data by extracting time series from specific locations along the fiber cable.

To diversify the dataset, experiments were conducted using three exciters at two of the three poles, under various environmental conditions, including sunny, windy, and rainy weather.

In our experiment, a frequency sweep signal with constant amplitude sweeping from 0 to 2000 Hz in 40 seconds and the resulting acoustic data was collected using the DAS system. The short-time Fourier transform of the DAS data revealed significant attenuation of higher frequencies by the exciter-pole-cable system compared to a lower frequencies. Consequently, we plotted the result for the sub-range of 0 to 500 Hz to focus on the lower frequencies that carry most of the energy. We observed the frequency sweep signal exhibits a distinct pattern, progressively increasing in frequency to 500 Hz over 10 seconds. A clear frequency shifting pattern, consistent with the sweep source signal, was observed, demonstrating the coupling of vibrations from the exciter to the cable within this range. When the signal frequency was around and below 150 Hz during the first 3 seconds, multiple source frequencies triggered broadband and strong nonlinear responses, believed to be associated with the resonance frequencies of the exciter-pole-cable system. At these resonance frequencies, the vibrational energy from the exciter was more efficiently absorbed, triggering stronger vibrations and harmonic frequencies.

In contrast, the weaker frequency responses observed when the source frequency was sweeping around 250 Hz (at 5 seconds) were likely due to the attenuation of vibration wave propagation through the media and the filtering effect of the coupling between components, e.g., from exciter to pole, and from pole to cable. These observations suggest focusing on the low-frequency range for feature extraction and learning.

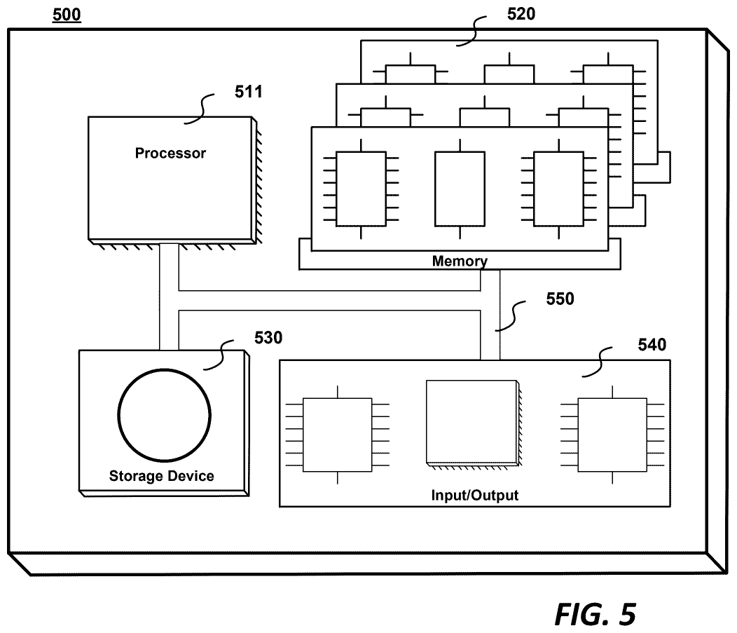

Finally, FIG. 5 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 500 as stored program control instructions.

Computer system 500 includes processor 510, memory 520, storage device 530, and input/output structure 540. One or more input/output devices may include a display 545. One or more busses 550 typically interconnect the components, 510, 520, 530, and 540. Processor 510 may be a single or mufti core. Additionally, the system may include accelerators etc., further comprising a system on a chip.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 830 may be a flash memory device, a disk drive, an optical disk device, or a tape device employing magnetic, optical, or other recording technologies.

Input/output structures 540 may provide input/output operations for system 500.

At this point, those skilled in the art will understand that we have developed and validated a novel DFOS placement strategy for resilient monitoring in critical infrastructure networks. By incorporating power supply constraints into the placement process, our method ensures robust monitoring coverage, even during power outages. The simulation results across utility and telecommunication networks demonstrate the method's effectiveness in maintaining critical link observability while minimizing deployment costs.

While we have presented our inventive concepts and description using specific examples, our invention is not so limited. Accordingly, the scope of our invention should be considered in view of the following claims.

1. A computer-implemented method for acoustic sensing data imputation in a fiber network, comprising:
collecting two-dimensional (2D) Distributed Acoustic Sensing (DAS) data using a DAS system connected to a fiber cable, the DAS data including acoustic event signals;
defining a diffusion probabilistic model comprising a diffusion process and a reverse process, where the diffusion process is a fixed Markov chain from an initial DAS data distribution (x₀) to a latent variable {x_{T});
training the model via the reverse process parameterized by Θ to generate high-quality acoustic data, where the reverse process is a Markov chain from x_{T} to x₀ that eliminates Gaussian noise;
conditioning the diffusion probabilistic model on an adjacent acoustic sensing signal to generate fiber sensing data;
generating imputed DAS data to enhance the spatial resolution and enrich important acoustic sensing events, thereby improving the detection of key acoustic events.

2. The method of claim 1, wherein the conditioning utilizes mel spectrograms that are upsampled to match the waveform length of the DAS data using transposed 2D convolutions.

3. The method of claim 2, further comprising incorporating the conditioner as a bias term in the dilated convolution of each residual layer of the model.

4. The method of claim 1, wherein the diffusion probabilistic model is a DiffOptics model having a network structure based on a bidirectional dilated convolution architecture comprising a stack of residual layers with multiple residual channels.

5. The method of claim 4, further comprising broadcasting an embedding vector over length and adding it to an input of every residual layer.

6. A system or acoustic sensing data imputation, comprising:
a distributed acoustic sensing (DAS) system configured to collect 2D spatio-temporal data from a fiber cable attached to utility poles, the data including acoustic events such as fuse cutoff blowing or transformer explosions;
an artificial intelligence (AI) processing unit configured to execute a conditional diffusion model (DiffOptics) to perform data imputation on the collected DAS data;
the conditional diffusion model further configured to i) learn the distribution of existing acoustic sensing data, ii) be conditioned on an adjacent acoustic sensing signal, and iii) generate synthetic acoustic data for optical sensing data imputation.
